(19) United States
(12) Patent Application Publication
(10) Pub. No.: US 2021/0114064 A1
(43) Pub. Date: Apr. 22, 2021

(54) Assistance Method For The Removal Of Mail Items From A Sorting Register

(71) Applicant: SIEMENS AKTIENGESELLSCHAFT, MUENCHEN (DE)

(72) Inventors: WOLFGANG BOENSCH, STOCKACH (DE); KONSTANTIN ROEHM, HEIDELBERG (DE)

(21) Appl. No.: 16/464,364

(22) PCT Filed: Oct. 12, 2017
(86) PCT No.: PCT/EP2017/076001

§ 371 Date: May 28, 2019

(30) Foreign Application Priority Data
Nov. 28, 2016 (EP) 16200949.2

(51) Int. Cl. B07C 7/00

(52) U.S. Cl. CPC B07C 7/005

(57) ABSTRACT

An assistance method for the removal of mail items from a sorting register provides the sorting register with a number of sorting compartments to which determining information, in particular delivery addresses, are assigned and in which sorted mail items are located. The mail items are removed from the sorting compartments according to a removal order provided by a sorting controller, in particular a route order sorting. A head-mounted display is provided and capable of contacting the sorting controller by a speech-based and/or gesture-based control for obtaining from the sorting controller additional sorting information in the head-mounted display relating to the removal sorting compartment by the sorting controller. The additional sorting information is displayed and/or announced by the head-mounted display. In this manner, it is possible for the operator/postal employee to perceive the compartment-specific sorting information in a very ergonomic manner during the removal work from the sorting compartments.

The present invention relates to an assistance method for the removal of mail items from a sorting register.

Mail items, such as for example flat postal items, are frequently sorted by hand into a sorting register at the end of a series of sorting procedures, so that a delivery person may prepare the mail items by way of example directly into the route order of the delivery person's route for the delivery procedure.

Methods are known for this purpose by way of example from the international patent application WO 2014/057185 A1, wherein the address of a mail item is ascertained and the sorting compartment that is assigned to this address is then displayed to a person who is charged with the sorting procedure. Consequently, this person receives the information that is required for sorting the mail item but feedback is not provided as to the mail item having been correctly sorted. In the event of an unintentional error or another act of negligence during the sorting procedure there is no longer a record regarding the whereabouts of the mail item. A solution to this problem is proposed in the European patent application EP 16 162 364.0.

However, after having been inserted into the sorting register (sorting wall), the sorted mail items are also to be removed according to a removal order that is provided by the sorting controller, for example in the order of the delivery route of a mail delivery person, and prepared for delivery. In so doing, there is also the desire to be able to display compartment-specific information. The information may be for example route information, the expected value of items in a specific compartment and the like. In this case, on the part of the customer a display and sensor technology is expected that automatically displays this compartment-specific information and in the event that the sorting compartment changes automatically switching to the next sorting compartment.

Currently, upon emptying the sorting register the operator operates the key pad of a data processing device that is associated with the sorting controller. This compartment-specific information is displayed on the associated screen. By virtue of operating a FORWARD or BACK key, the operator is able to switch to the next or previous sorting compartment. In this case, it is always necessary for the operator to look at the screen that is positioned remotely from the associated sorting compartment in order to be able to collect the compartment-specific information. As a consequence, the operator is required to move a correspondingly long distance in order to be able to view the screen and to be able to call up the compartment-specific information for the next sorting compartment.

The object of the present invention is therefore to specify an assistance method for the removal of mail items from a sorting register, wherein the operator is required to move a shorter distance in order to call up the compartment-specific information and is also able to absorb said information in a simpler manner and to switch to the next or previous sorting compartment.

This object is achieved according to the invention by means of an assistance method for the removal of mail items from a sorting register, said method having the following steps:
a) providing the sorting register with a number of sorting compartments to which determining information, in particular delivery addresses, are assigned and in which sorted mail items are located;
b) removing the mail items from the sorting compartments according to a removal order provided by a sorting controller, in particular route order sorting,
c) providing a head-mounted display which is capable of contacting the sorting controller by means of a speech-based and/or gesture-based control in order to obtain from the sorting controller additional sorting information relating to the respective removal sorting compartment in the head-mounted display; and
d) displaying and/or announcing the additional sorting information by means of the head-mounted display.

In this manner, it is possible for the operator to perceive the compartment-specific sorting information in a very ergonomic manner during the removal work from the sorting compartments. It is also possible for the operator to navigate from one sorting compartment to the next or to a previous sorting compartment in a likewise ergonomically advantageous manner in order to allow the compartment-specific sorting information for the sorting compartment selected by the operator to be displayed.

In an advantageous embodiment of the present invention, it is possible to provide that the additional sorting information relating to the respective removal sorting compartment comprises one or more of the information below:
a) information regarding the route, in particular route order information;
b) expected value for the number of mail items in the relevant sorting compartment;
c) special information, such as for example temporary repositioning of a target location (for example customer's post box) owing to a building measure or the like;
d) number of NO-ADVERTISING stickers for the target site assigned to the sorting compartment; and
e) display the next sorting compartment that is to be emptied.

When emptying the sorting compartment and preparing the mail items for delivery, the operator performs typical movement patterns in particular with their head. Thus, the operator holds their head relatively in a position looking straight ahead if they are removing mail items from a sorting compartment, and the operator lowers their head if they are placing the removed mail items into a delivery holder. Subsequently, the operator raises their head back up to view the next sorting compartment that is to be emptied. In an expedient embodiment of the present invention, the head-mounted display is therefore capable as far as the sensor is concerned of perceiving a downward and back upward movement as a request to call up from the sorting controller the additional sorting information regarding the next sorting compartment according to the removal order. The head-mounted display thus anticipates the removal order and on the basis of knowing this very typical movement pattern of the head of the operator said head-mounted display is able to request the compartment-specific sorting information for the next sorting compartment that is to be emptied.

In addition or also as an alternative thereto, the head-mounted display may be rendered capable as far as the sensor is concerned of perceiving a sideward movement to the left-hand side or to the right-hand side as a request to call up from the sorting controller the additional sorting information regarding the next previous and accordingly the next following sorting compartment according to the removal order.

Advantageous embodiments of the present invention are explained in detail below with reference to the attached drawing. In the drawing:

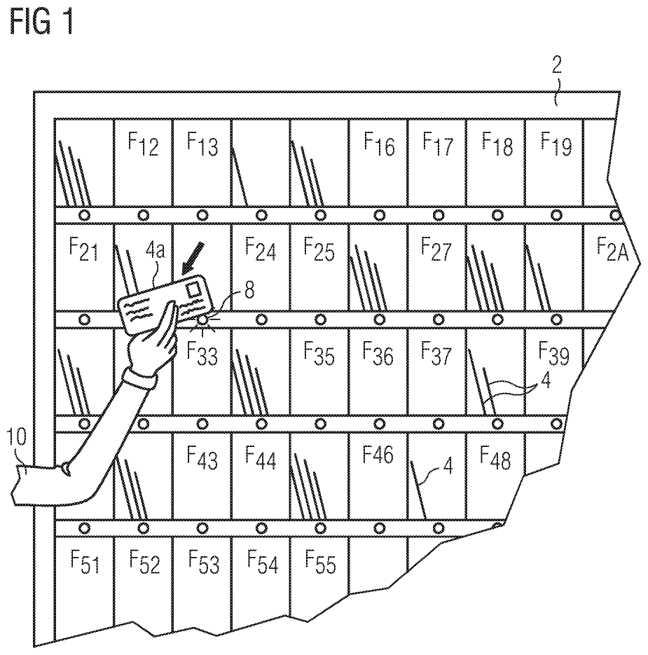

FIG. 1 shows a schematic illustration of a removal procedure from a sorting register that is equipped with sorting compartments; and

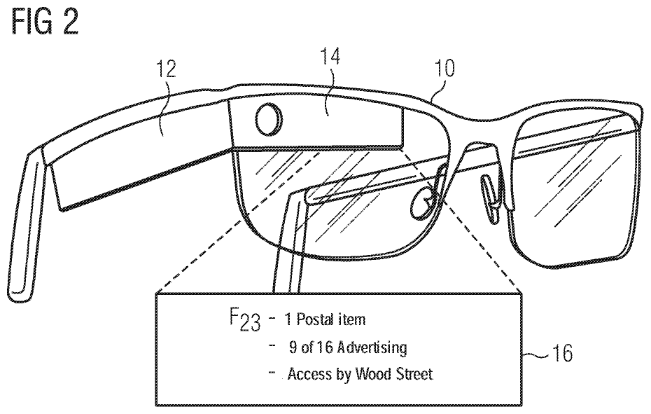

FIG. 2 shows a schematic illustration of an inner view of a head-mounted display having compartment-specific sorting information.

FIG. 1 illustrates schematically a procedure of removing a letter 4a from a sorting register 2 that is equipped with sorting compartments F. The sorting compartments Fₓy are logically continuously numbered as for the empty sorting compartments. Sorted flat mail items or also postal items 4 of all types are located according to a target address in the sorting compartments F that are in part filled. In the present exemplary embodiment, the letter 4a is removed from the sorting compartment F₂₃. The actual removal procedure now progresses as follows:
a) Determining information is assigned to the sorting compartments F prior to the actual sorting procedure. Said determining information may be by way of example already the specific delivery addresses for the postal items. However, said determining information may in this case also be only rough pre-sorting information for preparing an additional sorting route. Accordingly, all postal items 4 that are part of a logical group are now sorted in order into the sorting register 2 with the aid of a sorting controller that is not illustrated here in detail and has indicated to an operator the associated sorting compartment for the respective postal items.
b) If the postal items 4 are now to be removed accordingly from the sorting register 2 for example so as to be delivered by a postman, the sorting controller also specifies the order in which the sorting compartments are to be emptied. This order may by way of example correspond directly to the route order of the postman. The sorting controller may by way of example comprise an individual PC that is capable of being connected in a network and that in the present case has a wireless-interface to a head-mounted display 10, as is illustrated by way of example in FIG. 2.
c) The postal employer who is tasked with emptying sorting compartments now places this head-mounted display 10 on his head and starts the removal procedure on the sorting controller by way of example by means of a corresponding speech-based and/or gesture-based control command. The latter may be by way of example a rapid double nodding movement, which is detected by a sensor unit 12 that is located in the head-mounted display 10 and with which the postal employee signals that they are now ready for the removal procedure.
d) The postal employee is advised in a data field 14 in the head-mounted display 10 which sorting compartment is currently to be emptied according to the designated removal order. The content 16 displayed in the data field 14 is illustrated in an enlarged format below the head-mounted display 10 in the illustration according to FIG. 2. In this example, the sorting compartment F₂₃ is displayed as illustrated as in FIG. 1. In addition, the content 16 comprises additional compartment-specific sorting information, such as for example that only one postal item 4a (1 MAIL ITEM) is located in the sorting compartment F₂₃ for removal. Furthermore, the compartment-specific sorting information displays to the operator that only of 16 possible postboxes with general non-personally addressed advertising material (“9 of 16 ADV”) may be filled at this target site. In addition, the postal employee is notified of the fact that this target site is to be accessed during the course of the route order from Wood Street (“ACC BY WOOD STREET”).
e) If the postal employee has now removed the letter 4a from the sorting compartment F₂₃, they place the letter 4a in a delivery holder (not further illustrated in the figure) or postbag. In so doing, they first lower their head with the head-mounted display 10 and then raise their head back up after having placed the letter 4a into the delivery holder. The sensor unit 12 of the head-mounted display 10 detects the downward movement that follows an upward movement and said sensor unit now calls up from the sorting controller the content 16 for the next sorting compartment F that is to be emptied according to the removal order. The above described procedure of emptying a sorting compartment is now repeated until all postal items 4 that are associated with the logical group of postal items have been removed from the sorting register 2.
f) If the postal employee wishes to look at the content of the previous or next sorting compartment again with respect to the displayed content 16, they may do so by moving their head to the left-hand side or right-hand side. The sensor unit 12 detects this sideward movement accordingly and calls up the corresponding contents from the sorting controller. Numerous sideward movements are also possible in order to also be able to call up contents that are to be found further back or further in front.

In this manner, it is possible for the operator/postal employee to perceive the compartment-specific sorting information (contents 16) in a very ergonomic manner during the removal work from the sorting compartments F. It is also possible for the operator/postal employee to navigate from one sorting compartment to the next or a previous sorting compartment in a likewise ergonomically advantageous manner in order to allow the compartment-specific sorting information for the sorting compartment selected by the operator/postal employee to be displayed.

1-4. (canceled)

5. An assistance method for removing mail items from a sorting register, which comprises the steps of:
providing the sorting register with a plurality of sorting compartments to which determining information are assigned and in which sorted mail items are disposed;
removing the mail items from the sorting compartments according to a removal order provided by a sorting controller;
providing a head-mounted display being capable of contacting the sorting controller by means of a speech-based and/or gesture-based control in order to obtain additional sorting information in the head-mounted display relating to a respective removal sorting compartment of the sorting compartments by the sorting controller; and
displaying and/or announcing the additional sorting information by means of the head-mounted display.

6. The method according to claim 5, wherein the additional sorting information relating to the respective removal sorting compartment comprises at least one of the following items:
information regarding a route including route order information;
information regarding an expected value for the mail items in the respective removal sorting compartment;
special information, including temporary repositioning of a target location owing to a building measure;
information on a number of NO-ADVERTISING stickers for a target site assigned to the respective removal sorting compartment; and
information regarding a display of a next sorting compartment that is to be emptied.

7. The method according to claim 5, wherein the head-mounted display has a sensor for perceiving a downward and back upward movement as a request to call up from the sorting controller the additional sorting information regarding a next sorting compartment according to the removal order.

8. The method according to claim 5, wherein the head-mounted display has a sensor for perceiving a sideward movement to a left-hand side or to a right-hand side as a request to call up from the sorting controller the additional sorting information regarding a next previous and accordingly a next following sorting compartment according to the removal order.

9. The method according to claim 5, wherein:
the determining information includes delivery addresses; and
the removal order is route order sorting.

10. The method according to claim 6, wherein the target location is a customer's post box.
